(19) United States
(12) Patent Application Publication
(10) Pub. No.: US 2024/0327286 A1
(43) Pub. Date: Oct. 3, 2024

(54) MATERIAL CONTAINING NATURAL COLLOIDS AND WAX OF NATURAL ORIGIN WITH LIQUID-SOLID PHASE CHANGE

(71) Applicant: UNIVERSITE DE BRETAGNE SUD, Lorient (FR)

(72) Inventor: Yohan JACQUET, LORIENT (FR)

(73) Assignee: UNIVERSITE DE BRETAGNE SUD, Lorient (FR)

(21) Appl. No.: 18/580,796

(22) PCT Filed: Jul. 20, 2022
(86) PCT No.: PCT/FR2022/051448

§ 371 Date: Jan. 19, 2024

(30) Foreign Application Priority Data
Jul. 22, 2021 (FR) FR2107902

(51) Int. Cl. C04B 28/00; B28B 1/00; B33Y 10/00; B33Y 30/00; B33Y 70/00; C04B 24/34; C04B 111/00

(52) U.S. Cl. CPC C04B 28/001; B28B 1/001; B33Y 10/00; B33Y 30/00; B33Y 70/00; C04B 24/34; C04B 2111/00181

(57) ABSTRACT

A composition for 3D printing of construction materials, which includes: a mineral colloidal matrix of water and granular inclusions, the water being 30 to 50% of the weight of the granular inclusions; and 1 to 30%, preferably 3 to 20%, and still more preferentially 5 to 10%, by weight with respect to the weight of the granular inclusions. Also, a 3D printing process using this composition and the rigidified construction materials obtained by this process.

### TECHNICAL FIELD

The present invention relates to a composition for the 3D printing of construction materials, its printing method as well as the printed construction material, and in particular to a composition containing a mineral colloidal matrix composed of water and of granular inclusions for the 3D printing of construction materials and its printing method.

### PRIOR ART

A construction material is a material used for construction purposes, for example for the construction of buildings. Wood, cement, metals, bricks, concrete, clay are the types of construction materials most often used at present. The choice of these materials is generally based on their profitability for the construction projects. Numerous substances of natural origin, such as clay, sand, wood and rocks, and even plant fibres and plant aggregates have been used to build buildings. Besides natural materials, numerous products, more or less synthetic, manufactured by humans, are used.

Construction materials can generally be classified into two categories: the natural materials and the materials derived from the petrochemical industry, which can be designated as synthetic materials. The natural materials are those that are not or very little transformed by the industry, such as wood, cork, stone. Natural materials respect the environment and the health of living beings more since they do not spread dangerous substances in the construction environment. Few materials available on the international market are 100% natural. Synthetic materials are manufactured in industrial facilities after many human manipulations, like plastics and petroleum-based paints. Most often, these materials are derived from virgin resources that are not renewable.

Today, the prior art comprises all sorts of construction materials, but the most common are brick, concrete, metal, glass and clay. A brick is a block made of a material baked in the oven, generally clay or shale. Clay bricks are formed in a mould or more frequently by extrusion through a die and by then cutting them with an iron wire to the appropriate size in commercial manufacturing. Concrete is a composite construction material manufactured from the combination of aggregates and a hydraulic binder such as cement. The most common form of concrete is Portland cement concrete, which is composed of ore aggregates, generally gravel and sand, Portland cement and water. Concrete is not a renewable material and its environmental impact is very significant.

Over the last few years, throughout the world, more and more tall buildings have been built from wood because of the technical qualities of this material and the modern technical shaping possibilities, its low cost, its easy maintenance, its low intrinsic energy, its renewable nature. Moreover, wood is not dangerous waste.

Modern construction is a multi-billion dollar-industry, and the production of raw materials for construction purposes occurs on a worldwide scale. It is often a key governmental and commercial point between nations. Environmental preoccupations are also becoming a major worldwide subject with regard to the availability and the durability of certain materials and the extractions of such large quantities necessary for human habitats. The construction sector is the third most polluting sector in the world. It is responsible for 40% of the energy consumption, produces 36% of the CO2 ejected into the air, uses 50% of the raw materials and 21% of worldwide potable water.

Today, for the construction or the renovation of their home, many prefer the use of environmentally friendly construction materials. A construction material that respects the environment is a material that reduces the energy needs and reduces the impact on human well-being and the environment. There are numerous different materials that can be used in the construction industry that are environmentally friendly; from the foundations to the insulation, the inside and outside wall coverings, the flooring and the countertops.

An environmentally friendly construction material is a product that was designed to harm the environment as little as possible. A material per se can be environmentally friendly, for example wood. Or conventional materials can even become environmentally friendly according to the construction technique used. The various characteristics that materials and environmentally friendly techniques have are the following: renewal, reuse of waste, local availability, reduction of the pollution (air, soil, water), biodegradability, durability and energy efficiency. It is difficult to obtain a material that has all these properties.

The construction materials containing natural colloids are environmentally friendly construction geomaterials. They are raw materials available in large quantities, like clay, fine silt, mud, sedimentary alluvium. These natural colloids, like clay, require the presence of water to be shaped. They are considered to be sticky and viscous after the addition of water and are thus difficult to manipulate and shape. Clays have, however, a major defect related to drying, the volume of water inside the material which decreases leaves empty spaces, thus leading to a significant volume decrease of the material inducing a fragility of the material when it is used as a construction material. Moreover, these materials have the disadvantage of taking several days to dry at ambient temperature, thus making their use as construction materials disadvantageous with respect to the cement or concrete having fast rigidification and allowing a high construction speed. These geomaterials further have a high sensitivity to water thus inducing a non-negligible loss of mechanical strength: this control of the sensitivity to water is a key aspect for considering their use as construction materials on a large scale.

New techniques allowing to overcome the defects inherent in the use of materials containing natural colloids, in particular the long drying and the alteration of the properties upon contact with water, are thus sought. Such a modernisation will therefore allow the use of the materials containing natural colloids in various ways, whether as bricks, as prefabricated elements or as construction materials. There is also a need to modernise construction techniques, in order to adapt construction methods to these new materials for example via the use of 3D printing, also called additive manufacturing by extrusion, or by dynamic moulding via a suitable heating extrusion device.

The patent application WO2019/155143A1 describes for example a method for creating a construction material usable in the context of a construction by 3D printing. More precisely, the document discloses a method comprising the mixture of a clay product with water. The mixture is then heated and mixed with an organic acid, phytic acid, in order to complex the metal ions present inside the clay. The mixture is then neutralised by supplying a base, soda, to condense the complexes containing metal ions. Wax is added to the mixture as a thermo-reactive product and the mixture is heated in such a way that the thermo-reactive product is liquid. The mixture is then printed by extrusion and the hardening of the thermo-reactive product allows the maintaining of the geometric characteristics of the printed material.

The patent application EP3778238A1 describes a system and a method for preparing environmentally friendly construction elements. More precisely, the document discloses a system composed of clay, water, cement, a filler containing waste from the rice production industry and additives. The system allows the production of construction elements by a method comprising the creation of the system containing waste from the rice production industry. This mixture is then extruded through a nozzle in a predefined 3D coordinate system. This method allows the printing of walls layer by layer, each layer being deposited after the drying of the previous one. The additives present in the system allow to provide additional properties to the printed construction element. Thus, the addition of wax into the system allows to confer onto the construction element properties of impermeability and insensitivity to water.

There is therefore still a need for a composition containing products of totally natural origin allowing the 3D printing of environmentally friendly materials that are easy to produce and to handle which have excellent mechanical properties, which are insensitive to water and breathable, in order for the printed material to be usable as a construction material while having a positive environment impact.

### SUMMARY

The present invention thus proposes, according to a first aspect, a composition for the 3D printing of construction materials comprising:
a mineral colloidal matrix composed of water and of granular inclusions, and
from 1 to 30%, preferably from 3 to 20%, and even more preferably from 5 to 10% wax of natural origin by weight relative to the weight of the granular inclusions.

According to another aspect, a method for 3D printing of construction materials comprising the following steps is proposed:
incorporating the composition according to the first aspect of the present invention into a 3D printing device,
heating the mixture to a temperature lower than 100° C. and greater than or equal to the melting temperature of the wax of natural origin, and
printing the material in a predefined 3D coordinate system.

According to another aspect, a rigidified construction material containing a colloidal matrix of water and of granular inclusions comprising from 1 to 30%, preferably from 3 to 20%, and even more preferably from 5 to 10% wax of natural origin by weight relative to the weight of the granular inclusions is proposed.

According to another aspect, a construction element printed according to the method of the second aspect of the present invention is proposed.

### BRIEF DESCRIPTION OF THE DRAWINGS

Other features, details and advantages will appear upon reading the following detailed description, and upon analysing the appended drawings, in which:

FIG. 1 shows a material printed according to one embodiment.

FIG. 2 shows the change in the yield stress according to the temperature of materials printed according to one embodiment.

FIG. 3 shows the change in the deterioration of the mechanical properties due to the presence of water, of materials printed according to one embodiment according to the quantity of wax of natural origin.

### DETAILED DESCRIPTION

The present invention relates to a composition for the 3D printing of construction materials comprising:
a mineral colloidal matrix composed of water and of granular inclusions, and
from 1 to 30%, preferably from 3 to 20%, and even more preferably from 5 to 10% wax of natural origin by weight relative to the weight of the granular inclusions.

The mineral colloidal matrix composed of water and of granular inclusions represents the majority of the composition according to the present invention. “Majority” means at least 50% by weight of the total weight of the composition. It is composed of water as well as of granular inclusions. The respective quantity of water and of granular inclusions can vary according to the type of granular inclusions used, their physico-chemical activity and their specific surface areas.

According to one embodiment, the granular inclusions can be chosen from clay, limestone, silt, sedimentation mud, sedimentary alluvium and the mixture thereof.

Clay is a rocky natural material containing silicates or aluminosilicates having a granular structure of less than one micrometre. Limestone is a sedimentary rock mainly composed of calcium carbonate easily soluble in water which can be reduced to a powder, having a granulometric range of up to 100 micrometres, preferably up to 50 micrometres. Silt is a sedimentary formation, the granular structure of which is greater than one micrometre and less than a hundred micrometres. Sedimentation mud is a mixture of water and of fine sedimentary particles of silt and of clay, often coming from the industry of aggregate production. These materials are easily accessible since they are present in the form of natural deposits but also in the form of waste, industrial waste and coproducts of the construction industry mainly. They can thus be taken directly in nature or be reused with a view to recycling and reuse of waste, thus reducing the ecological impact of the industries producing these materials as waste.

According to one embodiment, the clay can be kaolin.

Kaolin is a white natural and not very cohesive clay composed of kaolinite, a mineral species containing hydrated aluminium silicate. Kaolin is a clay that is used in numerous industries, in particular the paper, medical and cosmetics industries. Kaolin is thus present in the natural state in the form of deposits or as industrial waste in large quantities. It thus has the advantage of being available in the natural state and of being able to be recycled when it is in the form of industrial waste with a view to recycling and reuse of waste.

The composition according to the invention also comprises from 1 to 30% by weight, preferably from 3 to 20% by weight, more preferably from 5 to 10% wax of natural origin by weight relative to the weight of the granular inclusions.

Wax is an organic compound with long carbon chains. There are two types of wax, the waxes of natural origin and the synthetic waxes. The waxes of natural origin, animal or plant, main consist of esters of fatty acid and of alcohol or glycol while the mineral waxes derived from petroleum are mainly extracted from solid hydrocarbon residues. In the present invention the term wax of natural origin covers the waxes of plant and animal origin. This type of wax is malleable at ambient temperature, hydrophobic and has a melting point greater than 30° C. varying according to the wax chosen.

Hot wax has a low viscosity and thus allows to significantly reduce the viscosity induced by the clay. The difficulties of pumping and of extrusion encountered with clays are frequently caused by a too-high viscosity and thus a flowing difficult to obtain. A sticky effect induced by this high viscosity can also be observed: the wax reduces this effect and allows to greatly facilitate the extrusion/pumping of the material.

The wax of natural origin allows to formulate a composition with liquid-solid phase change and to confer onto this composition the capacity to quickly rigidify at ambient temperature, thus allowing a shaping by 3D printing of the composition according to the first aspect of the invention. Since the 3D printing is carried out by successive deposition of layers one above the other, during the deposition of a layer n, the layer n−1 located directly below must be sufficiently rigidified to support the weight of the layer n and the assembly must not collapse. The speed of rigidification of the composition is directly linked to the weight percentage of wax in the composition. 1% wax of natural origin by weight relative to the weight of the granular inclusions is sufficient for the composition to be usable for 3D printing. Beyond 30% wax of natural origin by weight relative to the weight of the granular inclusions, the ratio between final mechanical strength and quickness of thermal setting becomes not very relevant.

The mechanical properties decrease proportionally to the quantity of natural wax added to the composition. For small quantities of wax of natural origin, the mechanical properties of the material coming from the composition are close to those of the mineral colloidal matrix alone and for large quantities of wax of natural origin, the material coming from the composition has reduced mechanical properties.

The wax of natural origin also allows to make the rigidified material containing the composition insensitive to water. Since wax is hydrophobic, mixing the wax with the mineral colloidal matrix containing water and granular inclusions allows to make the latter resistant to water after solidification. Since the mineral colloidal matrix, such as clay, is particularly sensitive to water, its use alone as a construction material poses numerous problems with regard to sealing, service life, alteration of the structure and its mechanical properties. The use of a wax allows to solve these problems. 1% wax of natural origin by weight relative to the weight of the granular inclusions suffices to significantly reduce the sensitivity of the material to water.

The wax of natural origin allows to make the rigidified material containing the composition according to the invention breathable. A breathable material is a material capable of evacuating humidity through it. This property is particularly advantageous for construction materials since it allows them to evacuate the humidity present inside the construction towards the outside. The materials containing natural colloids naturally have a porous structure. The incorporation of the wax of natural origin allows to make this porosity network thermally dependent. The temperature influences the viscosity of the wax and the surface tension between wax and granular inclusions. The quantity of wax implemented is adapted according to the size of the porosities of the material, the temperature of use and the viscosity of the wax at this temperature of use, as well as to the desired water vapour diffusion factor.

By choosing the nature and the weight proportion of wax of natural origin in the composition according to a first aspect of the invention, it is possible to modify the speed of rigidification and the mechanical properties of the material obtained from the composition. Thus, it is possible to adapt the weight proportion and the nature of wax according to the speed and the type of construction material that it is desired to print or extrude. For example, a structure requiring a material with a very fast speed of rigidification and good mechanical properties with a gravitational force unfavourable to the resistance of the structure, during and after construction, like vaults or overhangs, will thus need a significant weight proportion of wax of natural origin, greater than 10% and less than 30% by weight relative to the weight of the granular inclusions, preferably greater than 10% and less than 20%. On the other hand, a structure requiring a material with a speed of rigidification not necessarily fast, less demanding mechanical properties and with a gravitational force not very unfavourable to the resistance of the structure, like a house wall, can require a low weight proportion of wax of natural origin, greater than 1% and less than 10% by weight relative to the weight of the granular inclusions.

There are numerous types of materials containing natural colloids and very large geographic disparities. The natural colloids do not therefore have the same structure and the same properties according to the geographic zones. Thus, the weight proportion of wax necessary to achieve the properties required for the use that will be made of the composition can also vary because of these disparities. It is understood by a person skilled in the art that the weight proportion of wax can be adapted according to the type of natural colloid that will be used as the basis of the composition. For example, for the use of kaolin, a range of 1 to 5% wax of natural origin relative to the weight of kaolin can suffice to obtain mechanical and water-resistance properties adapted to construction.

According to one embodiment, the wax of natural origin can be chosen from soy wax, colza wax, hemp wax, sunflower wax, palm wax, carnauba wax, coco wax, candelilla wax, beeswax and the mixture thereof.

According to one embodiment, the composition according to the invention does not comprise a hardening agent other than the wax.

A hardening agent is a compound allowing to more quickly rigidify a construction material and protect it against the removal of the water during the rigidification which can lead to the creation of cracks in the material thus weakening the structure. The hardening agents are generally synthetic compounds used for concretes and cements in the construction field. In the composition according to the present invention, the wax of natural origin, which is a natural and environmentally friendly product, acts as a hardening agent while providing additional properties to the material, in particular insensitivity to water and thermo-dependent breathability. Thus, not using an additional hardening agent allows to obtain a composition that is easy to create, with few different ingredients, environmentally friendly, recyclable and reusable, while keeping the advantages of the use of a hardening agent.

According to one embodiment, the composition of the invention does not comprise rice-based materials.

The rice-based materials such as rice straw or rice braid are residues from the rice production industry and can be used as a filler in a construction material. However, the residues from the rice production industry are not easily available materials. Indeed, the production of rice is very unequally distributed in the world. Since the composition according to the invention has the advantage of being able to be created in any location, it appears to be advantageous and environmentally friendly to not include in the composition components not available in a nearby environment.

According to one embodiment, the composition of the invention further comprises a filler of mineral or plant origin, said filler being chosen from sand, gravel, wood chips, flax fibres or hemp chaff and the mixture thereof.

The colloidal material consists of granular inclusions and of coarser particles having a particle size greater than 0.2 μm according to the nature and the variability of the starting material used. The use of coarser particles, outside of the natural composition of the starting material used, can be considered for economic reasons. These coarser fillers can be of mineral origin, like sand or gravel, or come from biomass, like wood chips, flax fibres or hemp chaff. The dosage of the filler is determined by analysis of the mechanical gain and the economic potential related to their use. The weight quantity of filler can be up to three times the weight of the granular inclusions, preferably two times, preferably one time. Beyond this quantity, the mechanical strength can be greatly affected. A person skilled in the art will be able to determine the quantity of filler that allows to ensure a continuity of the matrix in order to not induce phenomena of local decohesion of the material.

Advantageously, sand, gravel, wood chips, flax fibres or hemp chaff are resources present in large quantities. Consequently, the costs associated with the use of sand, gravel, wood chips, flax fibres or hemp chaff for the manufacturing of the colloidal matrix of the invention are low.

Sand, gravel, wood chips, flax fibres or hemp chaff can come directly from waste, from coproducts, from recycling, and/or from the reuse of waste. Thus, the colloidal matrix of the invention has a considerable ecological advantage since it allows to propose a concrete use of waste or of coproducts.

In the sense of the present application, “recycled sand” designates the sand obtained by recycling and/or ground sand. Ground sand can be a coproduct of the crushing of gravel.

Advantageously, the recycled sand, wood chips, flax fibres or hemp chaff have a hydrophilic nature delayed in time.

A phenomenon of delayed absorption of water is observed when the colloidal matrix of the invention further comprises recycled wood chips, flax fibres or hemp chaff, thus allowing to improve the kinetics of the rigidification of the material.

A phenomenon of delayed adsorption of water is observed when the colloidal matrix of the invention further comprises recycled sand, thus allowing to improve the kinetics of the rigidification of the material.

According to a second aspect, a method for 3D printing of construction materials comprising the following steps is proposed:
incorporating the composition according to the first aspect of the present invention into a 3D printing device,
heating the mixture to a temperature of less than 100° C. and greater than or equal to the melting temperature of the wax of natural origin, and
printing the material in a predefined 3D coordinate system.

The first step consists in the incorporation of the composition according to the present invention into a 3D printing device. The composition is thus created upstream of the method and integrated into the 3D printing device. A 3D printing device is a device allowing the shaping of a material composed of the composition according to the invention. A 3D printing device consists of a tank containing the composition to be printed as well as an extrusion device allowing the deposition of the composition.

The second step consists in heating the composition to a temperature of less than 100° C. and greater than or equal to the melting temperature of the wax of natural origin. By heating the mixture, the wax of natural origin mixed with the mineral colloidal matrix composed of water and of granular inclusions is liquified. The heated mixture has a paste-like, viscous and not very sticky consistency. This consistency allows to manipulate and shape the composition easily.

The third step consists in printing the material in a predefined 3D coordinate system. Predefined 3D coordinate system is understood as the coordinates in a three-dimensional plane of the material to be printed. For example, for the printing of a straight wall segment, the predefined 3D coordinate system corresponds to a rectangular volume, the dimensions of which are those of the wall segment that it is desired to print. The printing is carried out layer by layer. That is to say that the composition is deposited in the predefined 3D coordinate system in the form of a succession of layers having a predefined thickness. This thickness ranges, in order of magnitude, from one centimetre to ten centimetres.

The exposure of the heated composition to the ambient temperature allows to cool the mineral colloidal matrix and the wax of natural origin. By cooling, the wax of natural origin distributed in the material solidifies and allows the rigidification of the entire material while ensuring the maintaining of the geometric characteristics of the layer deposited. Thus, when the entire layer is deposited and the printing device deposits the following layer, the deposited layer will already be rigidified thus allowing to support the following layer and avoiding the collapse of the structure.

The cohesion between the layers is greatly improved by the wax, there is no appearance of cold joints between two successive printed layers of the composition according to the invention. A cold joint is a discontinuity between two successive layers leading to the weakening of the material and the reduction of its cohesion. Moreover, the addition of wax allows to avoid the appearance of cracks which conventionally form in the constructions made of earth because of the removal of water during drying.

Finally, it is of interest to note that a lubricating effect on the walls of the printing device induced by the heating of the wax of natural origin reduces the sticky effect. The greater the heating, the more the sticky effect is reduced. This reduction in the sticky effect thus allows better pumpability of the heated composition according to the first aspect of the invention and a better surface appearance of the printed material.

According to one embodiment, the 3D printing device is easily movable horizontally and vertically in order to be able to print materials with large dimensions, such as wall elements.

According to one embodiment, the 3D printing device is an extrusion device, a pump with a controlled flow rate, or a projection nozzle.

According to one embodiment, the 3D printing device can be a mobile extrusion device supplied with material by a pump with a controlled flow rate.

An extrusion device is a device comprising a heated cylindrical sheath in which an endless screw turns and a nozzle. The heated cylindrical sheath allows the heating of the composition and the endless screw the mixture and the transport of the composition towards the nozzle. The nozzle has a size adapted to the material that must be printed, more particularly to the geometric dimensions of the layer that will be deposited in the predefined 3D coordinate system and to the maximum size of the particles present in the material.

According to one embodiment, the step of printing the material can comprise the cooling of the heated composition by a cooling device based on liquid nitrogen at the outlet of the 3D printing device, on a system for active cooling by air such as a fan or a system for cooling by forced heat exchange.

As explained above, the structural elements having a very unfavourable force of gravity during the construction like vaults or overhangs require a significant weight proportion of wax of natural origin, generally greater than 10% by weight relative to the weight of the granular inclusions in order to rigidify very quickly and have mechanical properties allowing the maintaining of the structure. It is however possible to use at the outlet of the 3D printing device a cooling device based on liquid nitrogen in order to immediately rigidify the deposited composition. Since the liquid nitrogen is at a temperature of less than −195.79° C., the contact of the deposited layer with the liquid nitrogen leads to the immediate solidification of the wax and the cooling of the mineral colloidal matrix. This immediate rigidification thus allows to overcome the gravity unfavourable for the printing of this type of structure and thus avoid its collapse.

According to a third aspect, the invention relates to a rigidified construction material containing a colloidal matrix of water and of granular inclusions comprising from 1 to 30%, preferably from 3 to 20%, and even more preferably from 5 to 10% wax of natural origin by weight relative to the weight of the granular inclusions.

As explained above, the addition of wax to a colloidal matrix of water and of granular inclusions allows, after rigidification of the composition, to confer onto the material obtained advantageous properties with regard to shaping and durability allowing it in particular to be used as a construction material.

According to one embodiment, the rigidified construction material containing a colloidal matrix of water and of granular inclusions can have at least one of the following properties: a compressive strength greater than 4 MPa, an insensitivity to water or a breathability property.

After rigidification, the composition of the colloidal matrix containing water and granular inclusions and from 1 to 30%, preferably from 3 to 20%, and even more preferably from 5 to 10% wax of natural origin by weight relative to the weight of the granular inclusions comprises almost no more water. The addition of wax of natural origin thus allows, during the removal of the water during the rigidification, to control the shrinkage of the rigidified material and thus the appearance of cracks. The absence of cracks and thus of weaknesses inside the material thus allows the latter to have mechanical properties sufficient for its use as a construction material. The addition of wax of natural origin thus confers onto the rigidified material containing the colloidal matrix consisting of water and of granular inclusions mechanical properties sufficient for its use as a construction material, in particular a mechanical compressive strength greater than 4 MPa. For comparison, a class B40 cinderblock has a compressive strength of 4 MPa. The wax thus allows to overcome one of the problems inherent to mineral colloidal matrices containing water and granular inclusions during their rigidification. The proportion of wax can be adapted to obtain the desired mechanical properties.

Moreover, as explained above, the mineral colloidal matrices containing water and granular inclusions, and more particularly containing clay, are materials that after rigidification are particularly sensitive to water. That is to say that the properties of these rigidified materials are clearly altered in the presence of water. This problem thus makes difficult the use of these materials as a construction material since the contact with water, for example during inclement weather, flooding or a period of high humidity, can weaken the inner structure of this rigidified material. Thus, the use of this material as a base material in the construction field is not possible without additional protection to protect it from water. The presence of 1 to 30%, 3 to 20%, and even more preferably of 5 to 10% wax of natural origin by weight relative to the weight of the granular inclusions allows to make the rigidified material very little sensitive to water and satisfies the requirements for a use as a construction material.

Finally, the presence of 1 to 30% wax of natural origin by weight relative to the weight of the granular inclusions in the rigidified material containing the mineral colloidal matrix of water and of granular inclusions allows to advantageously confer onto it the property of breathability. As explained above, a breathable material is a material easily evacuating humidity. This property thus allows to make the rigidified material containing the mineral colloidal matrix of water and of granular inclusions adapted for its use as a construction material, and more specifically as a single-component wall.

Advantageously, when the colloidal matrix of the invention further comprises sand, gravel, wood chips, flax fibres or hemp chaff that can come directly from waste, from coproducts, or from the recycling of waste, the speed of the method for 3D printing of construction materials of the invention is improved.

According to a fourth aspect, a construction element printed according to the method according to the second aspect of the present invention is proposed.

The method according to the second aspect of the invention thus allows the printing of a complete construction element from the composition according to the first aspect of the invention. Construction element is understood as a complete assembly that can be, for example, a wall element, a vault, a ceiling, an overhang or a complete construction such as a house. The construction element is composed of the rigidified material according to the third aspect of the invention and will thus have the advantageous properties thereof. A person skilled in the art will understand that the proportion of wax can be adapted according to the printed construction element in order for the construction element to have the properties necessary to maintaining the structure.

### EXAMPLES

### Example 1: Preparation of Rigidified Construction Material (FIG. 1)

A composition according to the invention is prepared by mixing:
1 kg of kaolinite coming from the Imerys Ploemeur Quarry (France)
45% water by weight relative to the total weight of kaolinite, and
5% by weight relative to the weight of kaolinite of soy wax having a melting point of 52-54° C. marketed by ADC.

The composition is integrated into a specific extruder designed for ceramic materials from the brand ECT with a double wall.

The mixture is mixed using a mixer integrated into the extruder and a temperature between 7° and 80° C. is maintained.

A material having dimensions of 2×12×7 cm is printed by successively depositing 6 layers continuously. A printed material is obtained as shown in FIG. 1.

### Example 2: Effect of the Quantity of Wax on the Maximum Acceptable Shear Stress Over Time

On the basis of example 1, 2 types of materials having different consistencies were poured into a container 7 cm in diameter and 3.5 cm high while varying the weight proportion of water relative to the weight of kaolinite in the composition:
Formulation 1: 35% water,
Formulation 2: 45% water.

These two materials are distinct: the first is relatively firm when hot and the second is more fluid. The speed of thermal setting over time was estimated.

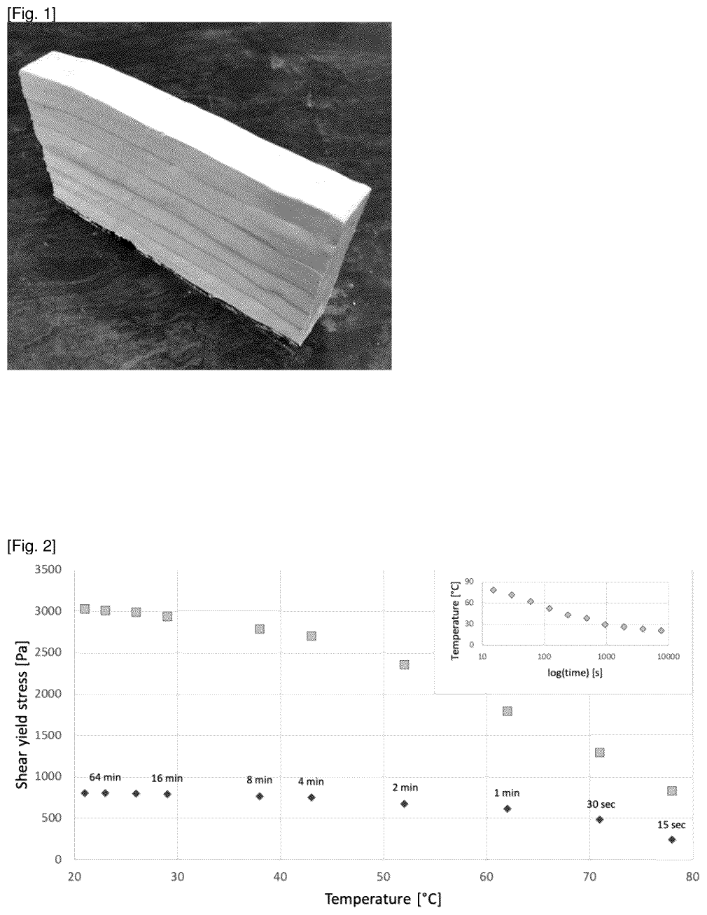

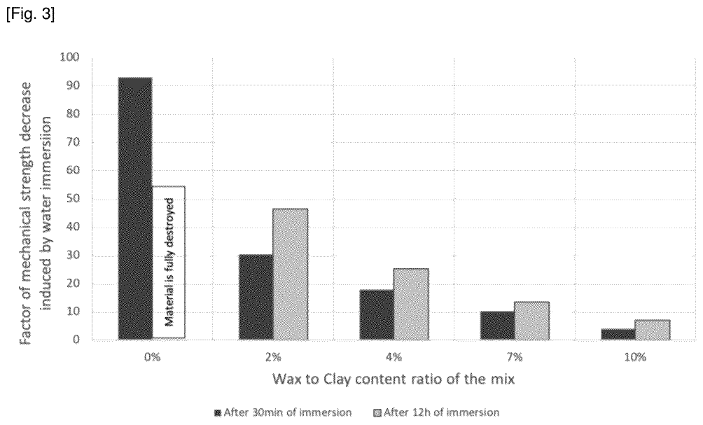

FIG. 2 shows the change in the yield stress according to the temperature and the time interval after exposure to ambient temperature, as well as the change in the temperature of the material over time. The yield stress is measured during the thermal setting at various temperatures by using a rheometer with vane geometry with a measurement gap of 4 mm and a fluted container in order to avoid the wall slip induced by the heated wax. These measurements are correlated to those carried out using a cone penetrometer (ISO17892-12 2004). These measurements show a significant rigidification during the first two minutes and a more progressive change beyond.

The yield stress after rigidification after 1 hour is respectively 3000 Pa for formulation 1 and 800 Pa for formulation 2.

### Example 3: Effect of the Quantity of Wax on the Water Resistance

On the basis of example 1, 5 test specimens having dimensions of 4×4×16 cm were poured while varying the weight proportion of wax relative to the weight of kaolinite in the composition:
Specimen 1: 0% soy wax,
Specimen 2: 2% soy wax,
Specimen 3: 4% soy wax,
Specimen 4: 7% soy wax, and
Specimen 5: 10% soy wax.

FIG. 3 shows the deterioration of the mechanical properties of the material after complete immersion of the rigidified material after 30 minutes of immersion and after 12 hours of immersion. The introduction of wax allows to significantly reduce the deterioration of the mechanical properties of the rigidified material. The more the proportion of wax increases, the less the deterioration of the mechanical properties.

1-13. (canceled)

14. A composition for the 3D printing of construction materials comprising:
a mineral colloidal matrix composed of water and of granular inclusions, the water representing 30 to 50% of the weight of the granular inclusions, and
from 1 to 30%, preferably from 3 to 20%, and even more preferably from 5 to 10% wax of natural origin by weight relative to the weight of the granular inclusions.

15. The composition for the 3D printing of construction materials according to claim 14, not comprising a hardening agent other than the wax.

16. The composition for the 3D printing of construction materials according to claim 14, not comprising rice-based materials.

17. The composition for the 3D printing of construction materials according to claim 14, wherein the granular inclusions are chosen from clay, limestone, silt, sedimentary alluvium, sedimentation mud and the mixture thereof.

18. The composition for the 3D printing of construction materials according to claim 17, wherein the clay is kaolin.

19. The composition for the 3D printing of construction materials according to claim 14, wherein the wax of natural origin is chosen from soy wax, colza wax, hemp wax, sunflower wax, palm wax, carnauba wax, coco wax, candelilla wax, beeswax and the mixture thereof.

20. The composition for the 3D printing of construction materials according to claim 14, further comprising a filler of mineral or plant origin, said filler being chosen from sand, gravel, wood chips, flax fibres or hemp chaff and the mixture thereof.

21. A method for 3D printing of construction materials comprising the following steps:
incorporating a composition according to claim 14 into a 3D printing device,
heating the mixture to a temperature lower than 100° C. and greater than or equal to the melting temperature of the wax, and
printing the material in a predefined 3D coordinate system.

22. The method for 3D printing of construction materials according to claim 21, wherein the printing step comprises the cooling of the heated composition by a cooling device based on liquid nitrogen at the outlet of the 3D printing device, on a system for active cooling by air such as a fan or a system for cooling by forced heat exchange.

23. The method for 3D printing of construction materials according to claim 21, wherein said 3D printing is an extrusion device.

24. A rigidified construction material containing a mineral colloidal matrix composed of water and of granular inclusions comprising:
from 5 to 10% wax of natural origin by weight relative to the weight of the granular inclusions.

25. The rigidified construction material containing a mineral colloidal matrix composed of water and of granular inclusions according to claim 24, wherein the material has at least one of the following properties: a compressive strength greater than 4 MPa, an insensitivity to water or a breathability property.

26. A construction element printed according to the method of claim 21.
